(19) United States
(12) Patent Application Publication
(10) Pub. No.: US 2026/0177129 A1
(43) Pub. Date: Jun. 25, 2026

(54) Hydraulic Connector for Connecting an Inner Tube to a Side Solenoid Valve and Damper System

(71) Applicant: Kyb Europe GmbH, Sucursal En Navarra, Ororbia (ES)

(72) Inventors: Javier Lizarraga Senar, Ororbia (ES); Jorge Trobajo San Martin, Ororbia (ES)

(21) Appl. No.: 19/423,690

(22) Filed: Dec. 17, 2025

(30) Foreign Application Priority Data
Dec. 19, 2024 (ES) P202431080

(51) Int. Cl. F16F 9/34; F16F 9/32; F16F 9/36

(52) U.S. Cl. CPC F16F 9/34; F16F 9/3207; F16F 9/36; F16F 2222/12

(57) ABSTRACT

The present invention relates to a hydraulic connector which can be used to hydraulically connect a solenoid valve to one side of a second tube of a damper system, the second tube being inside a first tube, the solenoid valve being located on an outer side of the first tube. The invention further includes the damper system which includes a first chamber inside the second tube, and a second chamber between the second tube and the first tube, such that the solenoid valve is configured to regulate passage of fluid between the second chamber and the first chamber, and the hydraulic connector is configured to channel fluid between the first chamber, through an intermediate side through hole in the second tube, and the solenoid valve.

### CROSS-REFERENCE TO RELATED APPLICATION

This application claims priority to Spanish Patent Application No. P202431080 filed Dec. 19, 2024, the disclosure of which is hereby incorporated by reference in its entirety.

### BACKGROUND OF THE INVENTION

### Field of the Invention

The invention consists of a hydraulic connector, particularly suitable for a damper system, comprising a tube located inside another tube, where it is required to regulate passage of damping liquid between the chambers generated by the arrangement of said tubes and at least one solenoid valve.

The invention falls within the technical field of hydraulically operated devices, in particular hydraulic dampers, and more specifically dampers for vehicles, such as those used in automobiles.

### Description of Related Art

A damper is a device intended for attenuating the oscillations of the suspension in an automobile by means of dissipating kinetic energy until said automobile recovers the equilibrium position thereof. In this way, the damper has a decisive influence on both the stability and comfort of the vehicle. In fact, the adjustment of the hydraulic load that it generates represents a compromise between both factors:
Stability, dynamic control of the vehicle is performed at low extension or compression speeds of the suspension and low oscillation frequencies, corresponding to the natural frequency of the sprung mass (cabin), which is typically in the range of 1-1.5 Hz for passenger cars. In this operating regimen, a high level of damping, i.e., high hydraulic loads, is required.

Comfort, control is mainly related to medium and high extension and compression speeds of the suspension which occur at medium or high oscillation frequencies. The reference frequency is the natural frequency of the unsprung mass (wheel suspension), which is typically in the range of 8-15 Hz for passenger cars. A higher degree of comfort is subject to a reduced level of damping, which allows uncoupling the movement of the wheels from the oscillations of the chassis. Therefore, it is desirable for the damper to be able to adjust the load level thereof to the characteristics of the oscillations it must attenuate.

Electronic dampers use solenoid valves to control the load level of the damper to match the oscillations to be damped. They also use an intermediate tube concentric with the inner tube to hydraulically connect the working chamber with the solenoid valve.

When the electronic damper comprises two control solenoid valves, one to control compression movements and the other for extension movements, these solenoid valves may be located at the ends of the damper tubes or in intermediate parts thereof, at different heights in the damper body, using two distinct intermediate tubes separated by O-rings.

This arrangement takes up a certain amount of space that is not always available in the vehicle or installation to be placed, due to the presence of the elements of the suspension system, making it necessary to locate the solenoid valves in other positions that are not possible with current designs due to the limitations caused by the damper components.

One of the problems encountered in designs where the solenoid valves cannot be connected to the ends of the tubes forming part of the damper system is determined by the connection between the chambers of said damper system and the solenoid valves. In other words, the way of conducting the damping liquid from each of the chambers generated by the arrangement of the tubes, to and from the solenoid valves, so that these solenoid valves determine the level of damping of the damper system, regulating the flow that passes through them.

This problem has been solved in different ways in the damper systems present in the state of the art, where the solenoid valves are located in intermediate parts of the outer tube, but in most cases limiting the possible arrangement of said solenoid valves to specific orientations and/or positions.

### SUMMARY OF THE INVENTION

The invention consists of a hydraulic connector particularly suitable for hydraulically connecting an intermediate solenoid valve to one side of a second tube of a damper system, the second tube being located inside a first tube, both tubes being straight in at least one section of the tube, being oriented in a longitudinal direction, the intermediate solenoid valve being located on an outer side of the first tube. Preferably, the tubes are cylindrical and arranged concentrically.

Thus, it is understood that the damper system to which the hydraulic connector can be connected comprises technical characteristics similar to those of the dampers mentioned in the state of the art, which have solenoid valves to regulate the passage of damping liquid.

The hydraulic connection means that it can convey or channel a fluid inside a tube to the solenoid valve and vice versa. The term “intermediate” means that the solenoid valve is located in an intermediate part of the two ends of the tube(s) comprising the damper system.

In addition to the indicated use in damper systems, the hydraulic connector could also be used for other systems in which a hydraulic connection such as the one defined above is required, i.e., where an external device, such as a valve, needs to be hydraulically connected to a tube located inside another tube.

From the defined tubes, the damper system comprises a first chamber inside the second tube, and a second chamber between the second tube and the first tube, the solenoid valve being configured to regulate passage of fluid, preferably a damping liquid, between the second chamber and the first chamber.

The damping liquid may be an oil comprising a viscosity suitable for the required use.

The main difference between the hydraulic connector and the existing systems in the state of the art is that said connector is configured to channel fluid between the first chamber, through an intermediate side through hole in the second tube, and the solenoid valve, as well as to connect to a perimeter of the intermediate side through hole in the second tube by means of a fluid-tight seal, configured to prevent passage of fluid between the first chamber and the second chamber, through said intermediate side through hole.

In other words, the hydraulic connector can hydraulically connect the chamber inside an inner tube (second tube) to a device (solenoid valve) on the outside of the outer tube (first tube), creating a channel for the passage of fluid, without generating contact between the two defined chambers.

In one embodiment, the hydraulic connector is configured to be located inside a transverse guide tube of the damper system, with a gap with respect to an inner surface of said transverse guide tube, which is rigidly joined at a first end to an outer side of the first tube, and the solenoid valve is fixed at a second end. The defined gap can allow fluid to be channelled between the solenoid valve and the second chamber located between the tubes, through the inside of the transverse guide tube and the outside of the hydraulic connector. The transverse direction means that the tube is oriented in a direction perpendicular to the longitudinal direction of the first and second tubes.

In one embodiment, the hydraulic connector comprises:
a guide element, comprising a tubular shape, configured to be rigidly fixed, at a second end, to the solenoid valve, wherein said guide element comprises an open tubular cavity, by means of a first opening located at a first end and by means of at least one through hole at a second end;
an elastic element;
a connecting element, annular in shape, comprising:
   a perimeter section fittingly joined to the tubular cavity of the guide element;
   a first flat end base, comprising a sealing area, located on the outside of the tubular cavity of the guide element; and
   an axial through hole.

The elastic element is configured to press the sealing area of the first flat end base of the connecting element against a flat surface of the second tube, on which the intermediate side through hole in the second tube is located, which can be considered a flat hole as it is in a flat surface, creating a fluid-tight seal therebetween (i.e., between the flat surface and the sealing area), blocking the passage of damping liquid between the first chamber and the second chamber, through the intermediate side through hole. Preferably, the elastic element is located between the second end of the guide element, within the open tubular cavity, and a second end base of the connecting element.

The axial through hole in the connecting element is configured to channel fluid between the first chamber, which passes through the intermediate side through hole in the second tube, and the solenoid valve. The fitted joint between the perimeter section of the connecting element and the tubular cavity of the guide element is configured to restrict the passage of fluid between said joint.

The term “restrict” is used to explain that the fitted joint may limit or block the passage of fluid entirely depending on the use of the hydraulic connector, as said fitted joint may also allow the passage of fluid between both parts, in one or both directions.

The purpose of this embodiment is that the hydraulic connector can absorb tolerances and misalignments in the assembly or manufacture, ensuring a correct connection between the components of the damper system. For example, if the flat face of the second tube is slightly inclined or rotated with respect to its ideal position (where the axial pressure would be exerted by the first flat end base), due to the manufacturing and assembly process of all the components, which require very high dimensional and geometric accuracies, the hydraulic connector can be adjusted to this inclination or rotation, due to the pressure exerted by the elastic element, maintaining the necessary watertight seal to prevent the fluid passing through the intermediate side through hole from escaping into the second chamber. It goes without saying that the described embodiment prevents small misalignments, due to the manufacturing and/or assembly process, from affecting the watertight seal between the intermediate side through hole and the axial through hole in the connecting element connecting to the solenoid valve. These small misalignments are very common, especially in damper systems with three tubes arranged as described above.

The contact between the first flat end base of the connecting element and the flat face of the second tube creates a hydraulic passage between the solenoid valve and the first chamber, separated from the second chamber, generating a pressure difference between the two chambers. As the pressure difference between both chambers increases (higher pressure in the first chamber than in the second chamber), there is a greater closing force between the hydraulic connector and the second tube.

As can be easily interpreted, when the fluid in the damper system is pressurised inside the second tube, for example, by the effect of the movement of a rod, said fluid exits under pressure through the intermediate side through hole in the second tube, also passing through the axial through hole in the connecting element and through the through hole in the second end of the guide element, to reach the solenoid valve. Depending on the configuration of said solenoid valve, part of the fluid passing through it is released into the second chamber at a lower pressure than the pressure in the first chamber.

As indicated above, the guide element is configured to be rigidly fixed to the solenoid valve, which, for the described operation of the hydraulic connector, must be rigidly joined to the transverse guide tube of the damper system, which in turn must be rigidly fixed to the first tube.

In one embodiment, the fitted joint between the perimeter section of the connecting element and the tubular cavity of the guide element is a ball-and-socket hinged connection that allows relative rotation between the two. This feature allows the connecting element to orient itself, orbiting in any direction, with respect to the guide element, within certain limits depending on the size and characteristics of the elements described, so that the first flat end base is tightly pressed to the flat surface of the second tube, even if there are small misalignments as mentioned above.

For example, if the direction of the axis of the intermediate side through hole in the flat surface of the second tube is not in the same direction as the axis of the open cylindrical tubular cavity of the guide element, the connecting element can be slightly rotated about itself so that its axial through hole meets the intermediate side through hole, allowing the passage of the damping liquid.

The elastic element may be configured to deform both axially and angularly to ensure that the first flat end base of the connecting element is aligned and in contact with the flat face of the second tube.

It should be noted that, during assembly, in the configuration of the damper system described, the second tube may have free axial and angular movement with respect to the first tube, and its position is determined by the position of the solenoid valve(s), where it is necessary to absorb the different manufacturing and assembly tolerances. Most current systems use solenoid valves with sufficient spacing between them to allow the use of two independent tubes hydraulically connected to each of the two solenoid valves (one extension solenoid valve and one compression solenoid valve) instead of the second tube. Therefore, in the systems described in the state of the art, in the case of having two intermediate solenoid valves connected to the same second tube, it is necessary to be able to absorb the manufacturing tolerances, since once the second tube is positioned with respect to a solenoid valve, the hydraulic connection with both solenoid valves must be ensured, absorbing these possible misalignments in position.

In one embodiment, the elastic element is an element selected from the group comprising: a coil spring, a compression spring, a wave spring and an elastomeric element which design and material ensures that it can deform under a load and subsequently return to its previous state.

In one embodiment, the sealing area of the first flat end base of the connecting element, located on the outside of the tubular cavity of the guide element, comprises at least one open groove that completely or partially surrounds, along the perimeter, the axial through hole in the connecting element, wherein said groove is configured to channel a fluid between said sealing area and the flat surface of the second tube, when said sealing area is pressing against the flat surface generating the fluid-tight seal.

This groove, channel or series of grooves or channels are located in the first flat end base of the connecting element, i.e., on the contact face of the connecting element with the flat surface of the second tube, to improve the sealing by creating a labyrinth seal, so that the damping liquid has to travel a long and difficult path to pass between the two surfaces. This so-called “labyrinth” seal is commonly used in hydraulic systems, where the pressure required to pass the fluid through said channels is much higher than the pressure required to pass it through an alternative passage.

In one embodiment, the hydraulic connector comprises an axial sealing gasket located between the first flat end base of the connecting element, surrounding the axial through hole in the connecting element.

This axial sealing gasket may be inserted into a similarly sized cavity in the first flat end base of the connecting element to improve the fit between the parts to be sealed in a watertight manner. Said axial sealing gasket makes it possible to achieve firmer sealing between the components it contacts, as it can be slightly deformed by the effect of the elastic element.

In one embodiment, the hydraulic connector comprises an elastic perimeter sealing gasket, fitted by tightening between the perimeter section of the connecting element and the open tubular cavity of the guide element. This perimeter sealing gasket may be included to achieve a completely watertight seal, and moreover, the perimeter section of the connecting element may comprise a suitable perimeter housing to accommodate said sealing gasket and prevent it from shifting from its position of use.

As this perimeter sealing gasket is an elastic element, it could deform sufficiently under specific pressure and, if necessary, even allow fluid to pass between the perimeter section of the connecting element and the open tubular cavity of the guide element. “Fluid” should be understood to mean both liquid and gas.

In an alternative embodiment where the hydraulic connector does not have this perimeter sealing gasket, the perimeter section of the connecting element could comprise an elastic part, allowing a tight fit with the open tubular cavity of the guide element.

In one embodiment, the perimeter sealing gasket comprises a U-shaped section, with
a movable flange configured to deform elastically due to a pressure exerted by a fluid flow, only in an axial direction, between the perimeter section of the connecting element and the open tubular cavity of the guide element.

In other words, with the hydraulic connector connected to the solenoid valve and to the tubes of a damper system, this movable flange allows the intermediate solenoid valve to be re-fed with fluid from the second chamber. In this way, said fluid can take the reverse path to the one it takes when the pressure in the first chamber is higher than the pressure in the second chamber, described above, by being directed to the solenoid valve from the second chamber and then back into the first chamber.

This situation can occur in some cases of damper system operation, such as with high-speed operation, where it is interesting to achieve a certain reverse passage of the damping liquid from the second chamber to the first chamber when the pressure in the second chamber is higher. For this purpose, the perimeter sealing gasket used is a flanged or lip sealing gasket that blocks the passage of the damping liquid in one direction, but allows it in the other direction.

When the pressure in the first chamber is higher than in the second chamber, the pressure of the fluid separates the flange or lips of the sealing gasket, preventing the passage of damping liquid between the two chambers.

When the pressure in the first chamber is lower than in the second chamber, the pressure of the fluid deforms the movable flange, or outer lip, of the perimeter sealing gasket, allowing a flow of damping liquid from the second chamber to the first chamber.

In one embodiment, particularly suitable when the solenoid valve is a extension solenoid valve, the first flat end base of the connecting element comprises a pressure-receiving area, on the perimeter external to the sealing area, located at a first separation distance from the sealing area in a direction normal to said sealing area. In other words, as if there were a staggering between the pressure-receiving area and the sealing area, both areas being preferably parallel, but not essential.

When the sealing area is in contact with the flat surface of the second tube, the pressure-receiving area is a separation distance from the flat surface comprising a channel configured to channel fluid. In this way, the connecting element is configured to be displaced, with respect to the guide element, in the direction normal to the pressure-receiving area, in a compression direction, when a pressure is applied to the pressure-receiving area that is higher than the pressure exerted on said connecting element in the opposite direction.

In other words, when the pressure of the fluid in the second chamber is higher than the pressure of the fluid in the first chamber, the fluid in the channel between the pressure-receiving area and the flat surface can generate such high pressure on the pressure-receiving area as to displace the connecting element in the opposite direction to that in which it is pushed by the elastic element, leaving the intermediate side through hole unblocked, allowing fluid to be exchanged between the first and second chambers through said hole until the pressures equalise, without the need for it to pass through the solenoid valve.

The ratio of the pressure-receiving area to the inner area of the connecting element, together with the force of the elastic element, controls the minimum opening pressure of the connecting element. In other words, the connecting element will be displaced in a compression direction depending on the pressure of the fluid in the first and second chambers, thus allowing rapid fluid recovery in the first chamber.

Another embodiment of the invention is a damper system comprising the hydraulic connector defined in any of the preceding embodiments. In other words, a damper system comprising a hydraulic connector which in turn comprises any of the features defined above, none of which are incompatible.

In said embodiment, the damper system comprises:
the first tube which is an outer tube of the damper system;
a third tube which is an inner tube of the damper system;
the second tube which is an intermediate tube of the damper system, located between the outer tube and the inner tube;
a rod configured to be displaced in a straight longitudinal direction relative to the outer tube;
a piston joined to a first end of the rod, displaceable in the longitudinal direction, through an inside of the inner tube, between a first end and a second end of said inner tube;
a extension chamber located inside the inner tube, between the piston and the first end of the inner tube;
a compression chamber located inside the inner tube, between the piston and the second end of the inner tube;
the second chamber which is an expansion chamber located between the outer tube and the intermediate tube;
the first chamber which is an intermediate chamber located between the intermediate tube and the inner tube;
damping liquid, configured to flow between the chambers of the damper system; and
the at least one intermediate solenoid valve which is a compression solenoid valve or a extension solenoid valve, configured to limit the longitudinal displacement of the rod in the compression and expansion direction, respectively.

The inner tube, the outer tube and the intermediate tube are straight, oriented in a longitudinal direction, rigidly joined to each other and preferably arranged concentrically.

As can be interpreted from the operation of the damper system, the size or internal volume of the extension and compression chambers varies according to the movement of the piston and rod, so that if the rod of the damper system performs an extension or extension movement with respect to the set of tubes (inner, intermediate and outer), the fluid from the extension chamber is channelled towards an upper part of the intermediate chamber, since these chambers are connected by an upper inner hole. If, on the other hand, the movement of the rod is a compression movement, the fluid in the compression chamber is pressed into a lower part of the intermediate chamber, since these chambers are connected by a lower inner hole. In both movements, the size or volume of the extension and compression chambers varies, expanding and contracting accordingly, directly and proportionally to each other.

The solenoid valve is joined to an area of the outer tube, at an intermediate part between two ends of said outer tube, and is configured to limit the longitudinal displacement of the rod by regulating a flow of damping liquid between the first chamber and the second chamber.

For example, if the intermediate solenoid valve, also called a side solenoid valve, is a extension solenoid valve, it is joined to an area or region of the outer tube, and is configured to control a flow of damping liquid between the first chamber and the second chamber. Specifically, that of the damping liquid in the first chamber which is pressed by the fluid in the extension chamber when the rod performs an expansion movement.

The hydraulic connector is configured to:
channel damping liquid between the intermediate chamber and the solenoid valve; and
regulate or restrict passage of damping liquid between the first chamber and the second chamber at the connection between the hydraulic connector and the intermediate tube.

In this way, the intermediate solenoid valve can be located on a side of the outer tube and the damping liquid in the first chamber can be directed to the intermediate solenoid valve without mixing with the damping liquid in the second chamber. This configuration is really complex and inventive because the second chamber is surrounded on the side by the intermediate chamber, where the intermediate solenoid valve is connected.

The fact that the hydraulic connector is configured to “regulate” or “restrict” the passage of fluid does not mean that it is always blocking the passage of damping liquid between the first chamber and the second chamber (at the connection to the intermediate solenoid valve), but that it can do so, depending on the use or needs of the damper system. For example, the hydraulic connector usually blocks the passage of damping liquid between the first chamber and the second chamber in a watertight manner, so that all the damping liquid exchanged between these chambers passes through the corresponding solenoid valve depending on the direction of movement of the rod, so that the force opposing the movement of the rod is greater or lesser depending on the flow allowed to pass through said valve. On the other hand, if required, the hydraulic connector can allow the first chamber and the second chamber to be connected to each other, at the connection to the intermediate tube, without the need for the damping liquid to pass through said intermediate solenoid valve, allowing the exchange of fluid, equalising pressures between both chambers.

This damper system may comprise two intermediate solenoid valves, one extension solenoid valve and one compression solenoid valve, or may have one intermediate solenoid valve and one solenoid valve located at one end of the tubes, depending on the design requirements.

In an embodiment in which the hydraulic connector comprises the guide element, the elastic element and the connecting element, as previously defined, the intermediate tube comprises the flat surface, in an intermediate part, which comprises the intermediate side through hole connecting the intermediate chamber to the solenoid valve.

In an embodiment in which the damper system comprises the hydraulic connector, of the embodiment in which the first flat end base of the connecting element comprises a pressure-receiving area, the solenoid valve of said damper system is a extension solenoid valve, since the configuration of releasing the intermediate side through hole in the connecting element, when the pressure in the second chamber is much higher than the pressure in the first chamber, is particularly suitable for connection to a extension solenoid valve. This is due to the need to fill the extension chamber with fluid from the second chamber when the rod performs a compression movement, as opposed to operation during the expansion movement, where the compression chamber receives fluid from the second chamber through the valve support.

Thus, the sealing area of the connecting element being in contact with the flat surface of the intermediate tube, the connecting element is configured to be displaced in a direction normal to said sealing area with respect to the guide element, separating the sealing area from the flat surface of the intermediate tube, generating a passage for exchanging damping liquid between the expansion chamber and the intermediate chamber, when the damping liquid in the expansion chamber exerts a pressure on the pressure-receiving area higher than the pressure exerted by the elastic element and the damping liquid, in the opposite direction, on the connecting element.

In the electronic dampers in the state of the art, comprising two intermediate control solenoid valves, the extension solenoid valve is equipped with a device which allows a return flow of damping liquid from the expansion chamber to the intermediate extension chamber during the compression movement of the rod. For this reason, in most current designs, the extension and compression solenoid valves are different.

With the defined embodiment, in which the first flat end base of the connecting element comprises a pressure-receiving area, this return flow of damping liquid can be carried out via the very hydraulic connector of the solenoid valve with the intermediate tube, thus on the one hand simplifying the extension solenoid valve and on the other hand allowing the use of the same solenoid valve design for both extension and compression.

In one embodiment, the damper system comprises at least one transverse guide tube rigidly fixed to the outer tube, preferably oriented in a direction transverse to the longitudinal direction of the outer tube. The hydraulic connector is located inside said transverse guide tube, with a sufficient gap to channel a flow of damping liquid between the solenoid valve and the second chamber.

In one embodiment, the damper system comprises two intermediate solenoid valves, a first intermediate solenoid valve which is the extension solenoid valve and a second intermediate solenoid valve which is the compression solenoid valve.

In one embodiment, the intermediate tube comprises two flat surfaces, at different intermediate parts of the intermediate tube, each comprising an intermediate side through hole (which can be considered a flat through hole) connecting the first chamber to the second chamber. The damper system thus comprises two hydraulic connectors, each connected to one of the two solenoid valves located at intermediate positions on the outer tube.

In one embodiment, the inner tube comprises at least one upper inner hole conveying the damping liquid between the extension chamber and the first chamber, and at least one lower inner hole conveying the damping liquid between the compression chamber and the first chamber. Hence, the intermediate solenoid valves control the passage of the damping liquid between the first chamber and the second chamber, because both the fluid in the compression chamber and in the extension chamber is directed to the first chamber.

In one embodiment, the damper system comprises a valve support connected to a lower end of the outer tube. This valve support can regulate the passage of damping liquid between the different chambers, to equalise or release pressures.

### BRIEF DESCRIPTION OF THE DRAWINGS

The terms Fig., Figs., Figure, and Figures are used interchangeably in the specification to refer to the corresponding figures in the drawings.

To complete the description, and for the purpose of helping to make the features of the invention more readily understandable, this specification is accompanied by a set of drawings constituting an integral part of the same, wherein by way of illustration and not limitation the following has been represented:

FIG. 1A shows a perspective view of the hydraulic connector.

FIG. 1B shows an elevation view, cut in half, of the hydraulic connector in FIG. 1A, showing the shape and arrangement of the components of said hydraulic connector.

FIG. 1C shows a profile view of the hydraulic connector, with a representation of the cutting plane shown in view 1B.

FIG. 1D shows an exploded view of the hydraulic connector shown in FIG. 1A.

FIG. 2 shows a partially cut-away elevation view of an intermediate solenoid valve connected to a hydraulic connector.

FIG. 3A shows a perspective view of a damper system comprising two intermediate solenoid valves, one extension solenoid valve and one compression solenoid valve, arranged at different heights with respect to the tubes.

FIG. 3B shows an elevation view, cut in half, of the damper system shown in FIG. 3A, showing the arrangement of the connector element with respect to the solenoid valves.

FIG. 4A shows a plan view of the damper system shown in FIG. 3B, showing that the sealing area of the first flat end base of the connecting element is in contact with the flat surface of the second tube creating a fluid-tight seal therebetween, the axis of the intermediate side through hole coinciding with the axis of the axial through hole in the connecting element.

FIG. 4B shows a plan view of the damper system as shown in FIG. 4A, but where the flat surface of the second tube is slightly inclined, rotated or angled at an angle relative to that shown in FIG. 4A, such that the connecting element is also angled or inclined at the same angle to maintain hermetic contact between the sealing area of the first flat end base of the connecting element and the flat surface of the second tube, where the intermediate side through hole is located.

FIG. 5A shows a detail view of FIG. 4A, showing the position of the sealing area of the first flat end base of the connecting element and of the flat surface of the second tube.

FIG. 5B shows a detail view of FIG. 4B, showing the position of the sealing area of the first flat end base of the connecting element and of the flat surface of the second tube, this flat surface being slightly inclined with respect to what would be an ideal position of use.

FIG. 6A shows a detail view of a connecting element comprising two small open grooves that completely surround, along the perimeter, the axial through hole in the connecting element. An elastic perimeter sealing gasket is also shown, fitted by tightening between the perimeter section of the connecting element and the tubular cavity of the guide element.

FIG. 6B shows a view similar to that shown in FIG. 6A, but instead of having two small open grooves, an axial sealing gasket is shown between the first flat end base of the connecting element and the flat surface of the second tube, surrounding the axial through hole in the connecting piece.

FIG. 6C shows a view similar to that shown in FIG. 6A, where the elastic perimeter sealing gasket comprises a U-shaped section with a movable flange.

FIG. 6D shows a view similar to that shown in FIG. 6C, where the first flat end base of the connecting element comprises a pressure-receiving area, on the perimeter external to the sealing area, located at a first separation distance from the flat surface of the second tube.

FIG. 7 shows a partial elevation view, cut in half, of a damper system, with a first intermediate solenoid valve, which is a extension solenoid valve, located at the top, and a second intermediate solenoid valve, which is a compression solenoid valve.

FIG. 8A shows a detail view of the intermediate solenoid valves in FIG. 7.

FIG. 8B shows a detail view of the first intermediate solenoid valve in FIG. 7, where the sealing area of the first flat end base of the connecting element is not in contact with the flat surface of the second tube.

### DESCRIPTION OF THE INVENTION

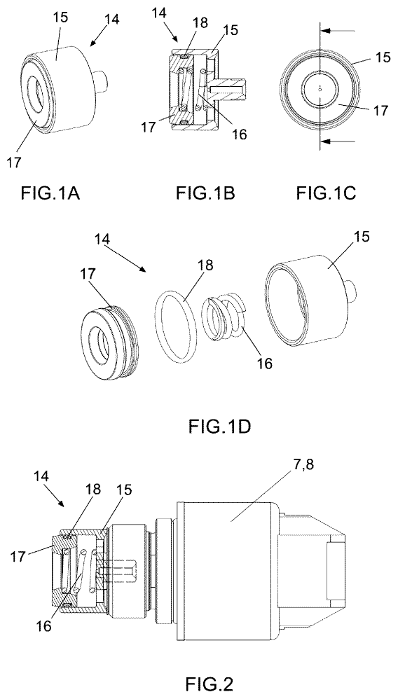

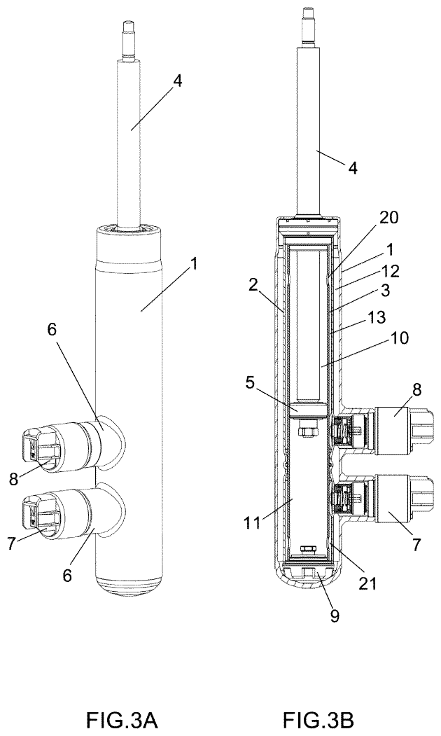

The present invention consists of a hydraulic connector (14), as shown in FIGS. 1A to 1D, and a damper system, as shown in FIGS. 3A and 3B, comprising the hydraulic connector (14).

Thus, in a preferred embodiment, the damper system comprises two solenoid valves (7, 8). A compression solenoid valve (7) and a extension solenoid valve (8), configured to control a flow of damping liquid between the first chamber (13) and the second chamber (12), which adjust the pressure opposing the longitudinal displacement of the rod (4) in the compression and expansion direction, respectively. Both solenoid valves (7, 8) are called intermediate solenoid valves because they are joined to different areas of a first tube (1), which is an outer tube of the damper system, wherein said areas are located in different intermediate parts of said outer tube.

As can be seen, the damper system is of the type comprising a second tube (2), which is an intermediate tube located between the outer tube and a third tube (3), which is an inner tube of the damper system, all of them straight, cylindrical, concentrically arranged, rigidly joined at their ends by means of a retainer or stopper, at an upper end which acts as a cover, and by a valve support (9), at a lower end of said tubes (1, 2, 3).

Like most damper systems, the damper system of the invention further comprises a rod (4) configured to be displaced in the straight longitudinal direction relative to the tubes (1, 2, 3), with a piston (5) joined to a first end of the rod (4), also displaceable in the longitudinal direction together with the rod (4), through an inside of the third tube (3), between the first end and the second end of said third tube (3).

The arrangement of the defined tubes (1, 2, 3) as well as the arrangement of the piston determine the chambers of the damper system. As shown in FIG. 3B, the system comprises a extension chamber (10), located inside the third tube (3), between the piston (5) and the first (upper) end of the third tube (3); a compression chamber (11), located inside the third tube (3), between the piston (5) and the second (lower) end of the third tube (3); a second chamber (12), consisting of an expansion chamber located between the first tube (1) and the second tube (2), and a first chamber (13), consisting of an intermediate chamber located between the second tube (2) and the third tube (3).

A damping liquid, preferably oil, flows through the inside of said chambers (10-13), as it adjusts to normal damping requirements given its conditions.

The operation of the damper system described is to regulate or limit the longitudinal displacement of the rod (4) with respect to the tubes (1, 2, 3), regulating the flow of damping liquid flowing between the first chamber (13) and the second chamber (12). Flows that are be passed through a solenoid valve (7, 8), whether the rod (4) is being displaced in the direction of expansion or compression.

Looking at FIG. 3B, it can be understood that the fluid in the compression chamber (11) is displaced towards the first chamber (13) (intermediate chamber) through a lower inner hole (21) in the inner tube (3), when the rod (4) performs a compression displacement. Specifically, it is displaced towards a lower part of the first chamber (13). The damping liquid in said first chamber (13) is channelled, for example, due to the geometry of the second tube (2), to the compression solenoid valve (7), passing through an intermediate side through hole (23) in said second tube (2) and a hydraulic connector (14). Depending on the configuration of the compression solenoid valve (7), a greater or lesser flow of damping liquid will be allowed, depending on the required stability and comfort, which will determine a greater or lesser displacement of the rod (4) with respect to the tubes (1, 2, 3). The damping liquid that passes through the compression solenoid valve (7) is directed to the second chamber (12) at a lower pressure than that in the first chamber (13).

On the other hand, in the event that the rod (4) performs an expansion displacement with respect to the tubes (1, 2, 3), the damping liquid in the extension chamber (10) is displaced towards the first chamber (13), or intermediate chamber, through an upper inner hole (20). Specifically, to an upper part of the first chamber (13). The damping liquid in said part is channelled, for example, due to the geometry of the second tube (2), to the extension solenoid valve (8), passing through another hydraulic connector (14). Depending on the configuration of the extension solenoid valve (8), a greater or lesser flow of damping liquid will be allowed, depending on the required stability and comfort, which will determine a greater or lesser displacement of the rod (4) with respect to the tubes (1, 2, 3). The damping liquid that passes through the extension solenoid valve (8) is directed to the second chamber (12) or expansion chamber at a lower pressure than that in the first chamber (13).

Thus, the problem of the invention consists of connecting the extension solenoid valve (8) and the compression solenoid valve (7) to the second tube (2), the solenoid valves being located in an intermediate part of the tubes (1, 2, 3), so that said solenoid valves (7, 8) can channel damping liquid between the first chamber (13) and the second chamber (12).

This problem is solved by the hydraulic connector (14) shown in FIGS. 1A to 1D, separately, or in FIG. 2, connected to a solenoid valve, which is the subject matter of the invention, independent of the damper system comprising said connector (14).

As shown in FIGS. 3A and 3B, both the extension solenoid valve (8) and the compression solenoid valve (7) are connected to one side of the first tube (1) by means of transverse guide tubes (6). In the embodiment shown, said transverse guide tubes (6) are straight, cylindrical tubes oriented in a direction transverse to the longitudinal direction of the first tube (1). The configuration described does not limit the transverse guide tubes (6) to both having the same transverse direction, or to both being located in the same longitudinal or transverse plane, but they can be located in any intermediate part of the first tube (1), even with different orientations.

Inside each of said transverse guide tubes (6) there is a respective hydraulic connector (14) which is rigidly joined to its corresponding solenoid valve (7, 8), which is joined to a corresponding transverse guide tube (6) and therefore joined to the first tube (1).

Each of the hydraulic connectors (14) shown allows the damping liquid to be channelled between the first chamber (13) and the corresponding intermediate solenoid valve (7, 8), and at the same time allows the passage of damping liquid to be restricted or prevented between the first chamber (13) and the second chamber (12), in the connection between the hydraulic connector (14) and the second tube (2).

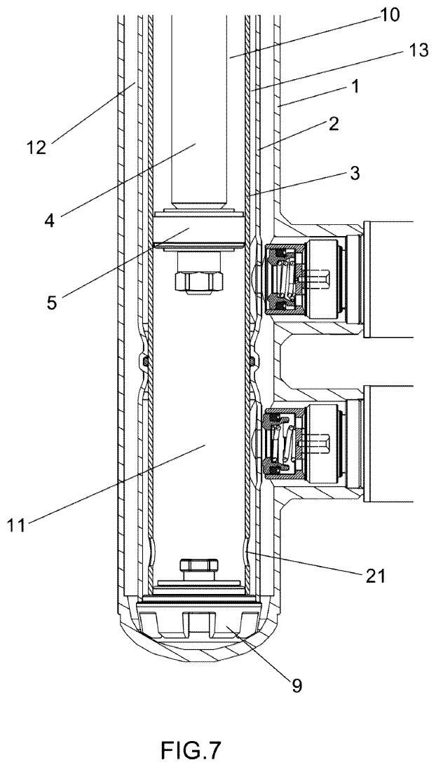

As shown in FIGS. 1A-1D and 2, the hydraulic connector (14) comprises a guide element (15), which has a tubular, preferably cylindrical, shape and is rigidly fixed, at a second end, to the intermediate solenoid valve. Said hydraulic connector (14) comprises an open tubular cavity, by means of a first opening, at one end, and by means of at least one through hole, at the second end. In other words, a damping liquid can pass through said open tubular cavity. To connect to the intermediate solenoid valve, the guide element (15) may comprise a projection, also cylindrical, insertable into the intermediate solenoid valve. As shown in FIG. 7, the guide element (15) is inside the transverse guide tube (6) with a gap between them that allows fluid to pass through said gap.

The hydraulic connector (14) further comprises an elastic element (16) comprising a compression spring shape, located in the open tubular cavity of the guide element (15), and a connecting element (17), in the shape of a ring or bushing, also located in the open tubular cavity of the guide element (15).

Said connecting element (17) in turn comprises a perimeter section fittingly joined, with a gap, to the tubular cavity of the guide element (15), a first flat end base comprising a sealing area (172), located on the outside of the tubular cavity of the guide element (15); and an axial through hole, typical of the elements in the shape of a ring or bushing.

In order for the hydraulic connector (14) to operate in the best possible way, the second tube (2) must have a flat surface (22) located in an intermediate part, which comprises an intermediate side through hole (23), also considered as a flat through hole, which connects the first chamber (13) and the second chamber (12).

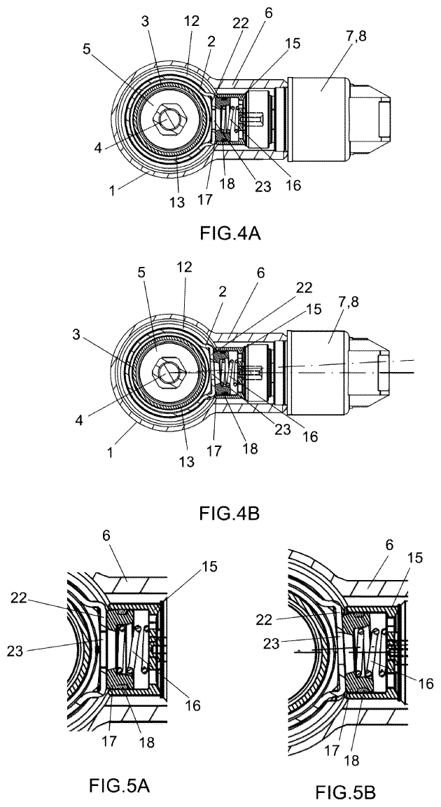

The operation of the hydraulic connector (14) can be interpreted from FIGS. 4A and 4B. As can be seen in these figures, which depict the top plan of the damper system, the elastic element (16) presses the sealing area (172) of the first flat end base of the connecting element (17) against a flat surface (22) of the second tube (2) creating a fluid-tight seal therebetween, blocking the passage of damping liquid between the second chamber (12) and the first chamber (13) through the intermediate side through hole (23). Thus, it is the axial through hole in the connecting element (17) that channels the damping liquid passing through the intermediate side through hole (23) in the second tube (2) to the corresponding intermediate solenoid valve, passing through the through hole in the guide element (15).

In order to prevent the damping liquid, which passes through the intermediate side through hole (23) and is channelled through the axial through hole in the connecting element (17), from escaping into the second chamber (12) without having passed through the intermediate solenoid valve, the fitted joint between the perimeter section of the connecting element (17) and the tubular cavity of the guide element (15) is configured to prevent said passage of fluid between the two elements.

Once the damping liquid has passed through the intermediate solenoid valve, it can be channelled through the gap between the hydraulic connector (14) and the transverse guide tube (6) into the second chamber (12).

FIG. 5A shows a detail of the fluid-tight seal created between the sealing area (172) of the first flat end base of the connecting element (17) against a flat surface (22), said flat surface (22) being in an ideal orientation and position. However, it is common that, during both the assembly and the manufacture of the components that make up the damper system, which require very high precision, misalignments are generated that must be resolved so that operation is not affected. For example, in both FIG. 4B and FIG. 5B, which shows a detail of FIG. 4B, it can be seen that the flat surface (22) is slightly tilted, orbited, pivoted or inclined with respect to what would be its ideal operating position. In fact, two “dash-dotted” lines (in FIG. 5B) have been depicted, one of the axis of the intermediate side through hole (23) and the other of the axis of the axial through hole in the guide element (15), in FIG. 4B, which allows this inclination to be interpreted. This misalignment may be due to the manufacturing or assembly tolerances of the system, and the hydraulic connector (14) must be able to assimilate and reduce them.

Given the configuration described, the elastic element (16) can generate sufficient pressure so that the connecting element (17) also tilts or inclines, maintaining the fluid-tight seal between the sealing area (172) of the first flat end base of the connecting element (17) and the flat surface (22), taking into account that the perimeter section of the connecting element (17) is inside the tubular cavity of the guide element (15), with a small gap that allows the watertight fit to be maintained.

Preferably, in fact, the joint between the perimeter section of the connecting element (17) and the tubular cavity of the guide element (15) is a ball-and-socket hinged connection, so that said connecting element (17) can be slightly inclined, in any direction, in order to be adjusted to the misalignment of the flat face (22) of the second tube (2). Said ball-and-socket hinged connection implies that, for example, the perimeter section of the connecting element (17) has a spherical or parabolic curved surface, i.e., not cylindrical, but complementary to the curved surface of the tubular cavity of the guide element (15).

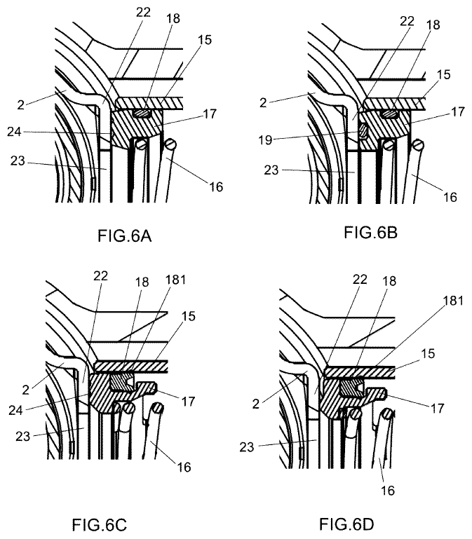

FIGS. 6A to 6D show different embodiments of the hydraulic connector (14), which can be implemented as required.

For example, in all of said figures, the hydraulic connector (14) comprises an elastic perimeter sealing gasket (18), fitted by tightening between the perimeter section of the connecting element (17) and the open tubular cavity of the guide element (15). This elastic perimeter sealing gasket (18) prevents the damping liquid passing through the intermediate side through hole (23) into the axial through hole in the connecting element (17) from escaping at the fitted joint between the connecting element (17) and the open tubular cavity of the guide element (15).

More specifically, in FIG. 6A, in addition to the perimeter sealing gasket (18), two small grooves (24) can be seen located in the first flat end base of the connecting element (17). Said grooves (24) completely surround, along the perimeter, the axial through hole in the connecting element (17). These grooves (24) allow a damping liquid to be channelled between the sealing area (172) and the flat surface (22) of the second tube (2).

The operation of said grooves (24) or channels located in the first flat end base of the connecting element (17) is to improve the sealing by creating a labyrinth seal, so that the damping liquid has to travel a long and difficult path to pass between the two surfaces and a simpler path in the other direction. This so-called “labyrinth” seal is very common in hydraulic systems, where the pressure required to pass the fluid through said channels is much higher than the pressure required to pass it through an alternative passage.

FIG. 6B does not show these grooves (24), but rather an alternative embodiment, which may be given with that shown in FIG. 6A, where the connecting element (17) comprises a housing, at the first flat end base, in which an axial sealing gasket (19) is located. Thus, when the sealing area (172) is pressed to the flat surface (22) of the second tube (2), the axial sealing gasket (19) is located between the first flat end base of the connecting element (17) and the flat surface (22) of the second tube (2), surrounding the axial through hole in the connecting element (17). Said axial sealing gasket (19) improves sealing, since it can be deformed, adjusting to the contact surfaces, by the effect of the pressure of the elastic element (16) preventing the passage of any fluid.

FIG. 6C shows an embodiment similar to that shown in FIG. 6A, wherein the perimeter sealing gasket (18) comprises a U-shaped section (although a V-shaped section would also be suitable), having two flanges, a fixed flange and a movable flange (181) configured to deform elastically due to a pressure exerted by a passage of flow of damping liquid, only in an axial direction, between the perimeter section of the connecting element (17) and the open tubular cavity of the guide element (15). In particular, said movable flange (181) can deform when the pressure in the second chamber (12) (expansion chamber) is much higher than the pressure in the first chamber (13) (intermediate chamber), allowing the damping liquid from said second chamber (12) to be directed to the open tubular cavity of the guide element (15), without passing through the intermediate solenoid valve, and from there to the first chamber (13). In other words, it allows the damping liquid to be recirculated in order to avoid depressions in the extension or compression chambers due to a high-speed movement of the rod (4). Likewise, due to the arrangement of the perimeter sealing gasket (18), as shown in FIG. 6C, the passage of damping liquid in the opposite direction is not allowed, since the deformation of said perimeter sealing gasket (18) due to high pressure in the first chamber (13) would generate a more secure seal between the contacting elements.

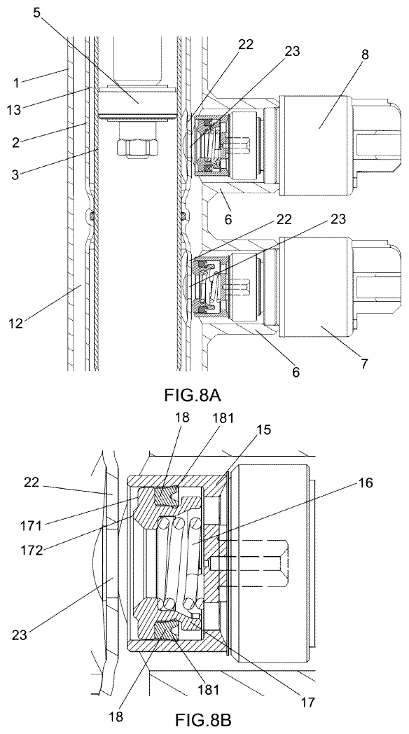

Lastly, FIG. 6D depicts an embodiment that is also depicted in FIGS. 7, 8A and 8B. In particular, these figures show a hydraulic connector (14) suitable for connecting to an intermediate solenoid valve which is a extension solenoid valve (8). Said hydraulic connector (14) comprises a flat pressure-receiving area (171), on the perimeter external to the sealing area (172), located at a first separation distance from the flat surface (22) of the second tube (2) when the sealing area (172) of the first flat end base of the connecting element (17) is in contact with the flat surface (22) of the second tube (2).

This separation distance between the pressure-receiving area (171) and the flat surface (22) comprises a channel configured to channel the damping liquid in the second chamber (12).

The operation of the hydraulic connector in this embodiment is that, for example, when the rod (4) performs a compression movement, the extension chamber (10) increases its internal volume and greatly reduces its pressure, so that the damping liquid in the first chamber (13) which is in contact with said extension chamber (10), via the upper inner hole (20), equalises this pressure. Thus, the pressure in the intermediate side through hole (23) as well as in the open tubular cavity of the guide element (15) of the hydraulic connector (14) connected to the extension solenoid valve (8) is lower than the pressure in the second chamber (12).

Since the damping liquid in the second chamber (12) surrounds the channel created in the space between the pressure-receiving area (171) and the flat surface (22) with a pressure higher than the pressure in the open tubular cavity of the guide element (15), the connecting element (17) can be pushed in the opposite direction to that in which it is pushed by the elastic element (16). When the magnitude of said pressure exceeds the force exerted by the elastic element (16), the connecting element (17) is displaced in the direction normal to the pressure-receiving area, generating a passage for exchanging damping liquid between the second chamber (12) and the first chamber (13).

This configuration allows the same type of solenoid valve to be used for both compression solenoid valves (7) and extension solenoid valves (8), as alternative systems require extension solenoid valves with a configuration that allows damping liquid feedback from the second chamber (12).

For compression solenoid valves (7), this embodiment becomes less necessary because the feedback between the second chamber (12) and the first chamber (13) can be carried out by the valve support (9).

### LIST OF ELEMENTS SHOWN IN THE FIGURES

1.—First tube (Outer tube in the damper system)
2.—Second tube (Intermediate tube in the damper system)
3.—Third tube (Inner tube of the damper system)
4.—Rod
5.—Piston
6.—Transverse guide tube
7.—Compression solenoid valve
8.—Extension solenoid valve
9.—Valve support
10.—Extension chamber
11.—Compression chamber
12.—Second chamber (Expansion chamber of the damper system)
13.—First chamber (Intermediate chamber of the damper system)
14.—Hydraulic connector
15.—Guide element
16.—Elastic element
17.—Connecting element
171.—Pressure-receiving area
172.—Sealing area
18.—Perimeter sealing gasket
181.—Movable flange
19.—Axial sealing gasket
20.—Upper inner hole
21.—Lower inner hole
22.—Flat surface
23.—Intermediate side through hole
24.—Groove

1. A hydraulic connector, configured to hydraulically connect an intermediate solenoid valve to one side of a second tube of a damper system; wherein the second tube is located inside a first tube, both tubes being straight, oriented in a longitudinal direction, wherein the intermediate solenoid valve is located on an outer side of the first tube; wherein the damper system comprises a first chamber inside the second tube, and a second chamber between the second tube and the first tube; wherein the solenoid valve is configured to regulate passage of a fluid, preferably a damping liquid, between the first chamber and the second chamber; wherein the hydraulic connector is configured to channel fluid between the first chamber, through an intermediate side through hole in the second tube, and the solenoid valve; and wherein the hydraulic connector is configured to connect to a perimeter of the intermediate side through hole in the second tube by means of a fluid-tight seal configured to prevent the direct passage of fluid between the first chamber and the second chamber, through said intermediate side through hole.

2. The hydraulic connector according to claim 1, configured to be located inside a transverse guide tube of the damper system, with a gap with respect to an inner surface of said transverse guide tube, which is rigidly joined at a first end to an outer side of the first tube, and the solenoid valve is fixed at a second end.

3. The hydraulic connector according to claim 1, wherein the hydraulic connector comprises:
a guide element, comprising a tubular shape, configured to be rigidly fixed, at a second end, to the solenoid valve, wherein said guide element comprises an open tubular cavity, by means of a first opening located at a first end and by means of at least one through hole at a second end;
an elastic element;
a connecting element, annular in shape, comprising:
a perimeter section fittingly joined to the tubular cavity of the guide element;
a first flat end base, comprising a sealing area, located on the outside of the tubular cavity of the guide element; and
an axial through hole;
wherein the elastic element is configured to press the sealing area of the first flat end base of the connecting element against a flat surface of the second tube, on which the intermediate side through hole in the second tube is located, creating a fluid-tight seal therebetween; wherein the axial through hole in the connecting element is configured to channel fluid between the first chamber, which passes through the intermediate side through hole in the second tube, and the solenoid valve; and wherein the fitted joint between the perimeter section of the connecting element and the tubular cavity of the guide element is configured to restrict the passage of fluid between said joint.

4. The hydraulic connector according to claim 3, wherein the fitted joint between the perimeter section of the connecting element and the tubular cavity of the guide element is a ball-and-socket hinged connection.

5. The hydraulic connector according to claim 3, wherein the elastic element is an element selected from the group comprising: a coil spring, a compression spring, a wave spring and an elastomeric element.

6. The hydraulic connector according to claim 3, wherein the sealing area of the first flat end base of the connecting element comprises at least one open groove that completely or partially surrounds, along the perimeter, the axial through hole in the connecting element, wherein said groove is configured to channel a fluid between said sealing area and the flat surface of the second tube, when said sealing area is pressing against the flat surface generating the fluid-tight seal.

7. The hydraulic connector according to claim 3, wherein the hydraulic connector comprises an axial sealing gasket located on the first flat end base of the connecting element, surrounding the axial through hole in the connecting element.

8. The hydraulic connector according to claim 3, wherein the hydraulic connector comprises a perimeter sealing gasket, fitted by tightening between the perimeter section of the connecting element and the open tubular cavity of the guide element.

9. The hydraulic connector according to claim 8, wherein the perimeter sealing gasket comprises a U-shaped section, comprising a movable flange configured to deform elastically due to a pressure exerted by a fluid flow, only in an axial direction, between the perimeter section of the connecting element and the open tubular cavity of the guide element.

10. The hydraulic connector according to claim 3, wherein the first flat end base of the connecting element comprises a pressure-receiving area, on the perimeter external to the sealing area, located at a first separation distance from the sealing area in a direction normal to said sealing area; wherein the sealing area being in contact with the flat surface of the second tube, the pressure-receiving area is a separation distance from the flat surface comprising a channel configured to channel fluid; and
wherein the connecting element is configured to be displaced, with respect to the guide element, in the direction normal to the pressure-receiving area, in a compression direction, when a pressure is applied to the pressure-receiving area that is higher than the pressure exerted on said connecting element in the opposite direction.

11. A damper system comprising the hydraulic connector defined in claim 1, and wherein the damper system further comprises:
the first tube which is an outer tube of the damper system;
a third tube which is an inner tube of the damper system;
the second tube which is an intermediate tube of the damper system, located between the outer tube and the inner tube;
a rod configured to be displaced in a straight longitudinal direction relative to the outer tube;
a piston joined to a first end of the rod, displaceable in the longitudinal direction, through an inside of the third tube, between a first end and a second end of said third tube;
a extension chamber located inside the third tube, between the piston and the first end of the third tube;
a compression chamber located inside the third tube, between the piston and the second end of the third tube;
the second chamber which is an expansion chamber located between the outer tube and the second tube;
the first chamber which is an intermediate chamber located between the second tube and the third tube;
the damping liquid, configured to flow between the chambers of the damper system; and
the intermediate solenoid valve which is a compression solenoid valve or a extension solenoid valve, configured to limit the longitudinal displacement of the rod in the compression and expansion direction, respectively;
wherein the third tube, the first tube and the second tube are straight, oriented in a longitudinal direction, rigidly joined to each other and preferably arranged concentrically; and
wherein the solenoid valve is joined to an area of the first tube, at an intermediate part between two ends of said first tube, and is configured to control a flow of damping liquid between the first chamber and the second chamber;
wherein the hydraulic connector is configured to:
channel damping liquid between the first chamber and the solenoid valve; and
regulate or restrict passage of damping liquid between the second chamber and the first chamber at the connection between the hydraulic connector and the second tube.

12. The damper system according to claim 11, comprising the hydraulic connector, wherein the second tube comprises the flat surface, in an intermediate part, which comprises the intermediate side through hole connecting the first chamber to the second chamber.

13. The damper system according to claim 11, comprising the hydraulic connector, wherein the solenoid valve is a extension solenoid valve and wherein, the sealing area of the connecting element being in contact with the flat surface of the intermediate tube, the connecting element is configured to be displaced in a direction normal to said sealing area with respect to the guide element, separating the sealing area from the flat surface of the second tube, generating a passage for exchanging damping liquid between the second chamber and the first chamber, when the damping liquid in the second chamber exerts a pressure on the pressure-receiving area higher than the pressure exerted by the elastic element and the damping liquid, in the opposite direction, on the connecting element.

14. The damper system according to claim 11, comprising the hydraulic connector, wherein the damper system comprises the at least one transverse guide tube rigidly fixed to the first tube, preferably oriented in a direction transverse to the longitudinal direction of the first tube; wherein the hydraulic connector is located inside said transverse guide tube, with a sufficient gap to channel a flow of damping liquid between the solenoid valve and the second chamber.

15. The damper system according to claim 11, comprising two intermediate solenoid valves, a first intermediate solenoid valve which is the extension solenoid valve and a second intermediate solenoid valve which is the compression solenoid valve, wherein each of said intermediate solenoid valves is joined to a different area of the same or different intermediate parts of the first tube and is configured to regulate a different flow of damping liquid between the first chamber and the second chamber.

16. The damper system according to claim 12, wherein the second tube comprises two flat surfaces, at different intermediate parts of said second tube, each comprising an intermediate side through hole connecting the first chamber to the second chamber; and wherein the damper system comprises two hydraulic connectors, each connected to one of the two solenoid valves.

17. The damper system according to claim 11, wherein the third tube comprises at least one upper inner hole conveying damping liquid between the extension chamber and the first chamber, and at least one lower inner hole conveying damping liquid between the compression chamber and the first chamber.

18. The damper system according to claim 11, comprising a valve support connected to a lower end of the first tube.
